(19) United States
(12) Patent Application Publication
(10) Pub. No.: US 2005/0177600 A1
(43) Pub. Date: Aug. 11, 2005

(54) Provisioning of services based on declarative descriptions of a resource structure of a service

(75) Inventors: Tamar Eilam, New York, NY (US); Liana L. Fong, Irvington, NY (US); Guerney D. H. Hunt, Yorktown Heights, NY (US); Michael H. Kalantar, Millwood, NY (US); Lily B. Mummert, Mahopac, NY (US); John A. Pershing JR., Cortlandt Manor, NY (US)

Correspondence Address: Louis P. Herzberg;Intellectual Property Law Dept., IBM Corporation, P.O. Box 218, Yorktown Heights, NY, 10598, US

(73) Assignee: International Business Machines Corporation, Armonk, NY (US)

(21) Appl. No.: 10/776,705

(22) Filed: Feb. 11, 2004

(51) Int. Cl. G06F 17/00

(52) U.S. Cl. 707/104.1

(57) ABSTRACT

The present invention is directed to provisioning and managing computing services in a computing utility system. It receives a Concrete Resource Model describing a desired resource structure. It uses a representation of the infrastructure, including resources, configuration, capabilities and constraints, as a knowledge subsystem. The method generates and executes provisioning actions to affect the infrastructure resources by creating a resource structure that matches the description in the Concrete Resource Model and satisfies the requirements described in the input. The method can be used to create new computing services, to destroy existing computing services, to modify the resource combination allocated to a computing service, or the configuration of these resources. Provisioning actions, generated, can be executed immediately, or saved and executed later, and possibly many times. Provisioning actions may be regenerated using the method whenever infrastructure characteristics, or the service requirements change.

### CROSS REFERENCES

The present application is cross-referenced to application entitled “Automatic Provisioning of Services Based on a High Level Description and an Infrastructure Description,” having docket number YOR920040003US1, even dated herewith, and which is included herein by reference in entirety for all purposes.

### FIELD OF THE INVENTION

The present invention is directed to provisioning and management of a set of computing services in a computing utility system, based on a declarative description of the resource structure of the desired service.

### BACKGROUND

The cost and complexity of managing IT infrastructure continues to grow rapidly. Several factors contribute to this trend. First, IT infrastructures today are based on a distributed network of heterogeneous platforms and applications. In such an environment, resources, their capabilities, and behavior, are represented differently. They are therefore harder to compare and reason about. Interdependencies between resources, in which one resource's behavior is affected by another one, are not well represented or understood. Administrative personnel need to exercise knowledge of every platform, application and network appliance used, as well of how they can be assembled together for a particular purpose.

Second, in a highly competitive business environment, businesses must respond quickly to market changes. Such changes may impose new requirements on the IT infrastructure, such as supporting new computing services or applications, upgrading resources, incorporating new ones, or changing the network structure. Realizing these changes is often a manual, tedious, and error prone process. In particular, as configuration changes are made, new IT management processes need to be defined, and existing processes may need to be updated.

Finally, service providers are moving towards an SLA-based service delivery model in which the set of resources allocated to a customer is dynamically adjusted based on workload and performance. Reconfiguring infrastructure resources dynamically in response to customer needs demands prompt attention from administrative personnel increasing operational cost. Therefore, a clear requirement of businesses today is to reduce the cost of maintaining an IT infrastructure by reducing the overall complexity and the level of required human operation.

A common approach to addressing these challenges is incorporating automation into the operation of the system. Common tasks such as adding a server to a computing service when the load increases, or installing software on a server, are automated, thereby reducing human involvement, the time to complete the task, and the probability for human errors. Workflows are often used as a vehicle for automation because they are particularly well suited for coordinating the execution of a set of activities that are long lived, tracking progress of activities, and incorporating human interaction where necessary. Provisioning engines, including a workflow engine, and some useful set of workflows organized in some structured way, are emerging as a means to achieve the goal of reducing the cost through automation.

Automating the operation of the infrastructure, even by utilizing a provisioning engine, does not fully address the aforementioned challenges. Automation procedures are often specific to a particular infrastructure, computing environment, and service. When coding an automation procedure it is impossible to predict all future changes in the service or infrastructure. Therefore statically defined automation procedures are likely to require change. For example, changing from a one-tier to a two-tier architecture, or adding resources with new capabilities, can require a complex re-implementation of the automation procedures. This task is further complicated by the many interdependencies between resources that are often implicit, by the combinatorial large number of possible allocations and configurations of a given set of resources, by the variety of possible computing services with different requirements, and by the many and rapidly evolving types of hardware and software resources. Therefore there is a need to be able to describe a computing service independent of a particular infrastructure, to describe the resources in a service provider's infrastructure and their interdependencies, and to automatically generate the instructions to provision and manage the service on the resources in the infrastructure.

### SUMMARY OF THE INVENTION

Thus, this invention provides a process for performing provisioning given a declarative description of a desired resource structure. A method is provided which determines how to assemble the desired resource structure from the building blocks available in the infrastructure. The method generates provisioning actions that affect the infrastructure to create a resource structure that matches the declarative description given in a Concrete Resource Model. Automatic generation of provisioning actions facilitates consistent implementations, and reduces error. The instructions could be embodied in a form such as a workflow that would serve as input to a provisioning engine. The method can be used to perform provisioning, including creating a new service environment, destroying an existing one, modifying the combination of resources allocated to a computing environment, modifying their configuration, or any combination of the above.

In an example embodiment, the present invention includes a method for provisioning in a computing utility infrastructure. The method comprising: obtaining a Concrete Resource Model describing a desired resource structure; and using the Concrete Resource Model to generate at least one provisioning action to create a matching resource structure in the computing utility infrastructure.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 The system in which the invention is used;

FIG. 2 High level view of the management elements that are described in this invention;

FIG. 3 shows elements of the knowledge subsystem;

FIG. 4 shows an example of a Concrete Resource Model;

FIG. 5 shows an example of a system structure with a scientific computing cluster service environment;

FIG. 6 shows an example of an execution of the Concrete Model Processing Engine; and

FIG. 7 shows a Concrete Model Processing Engine process.

### DESCRIPTION OF THE INVENTION

The invention provides methods, systems and apparatus for generating provisioning actions given a declarative description of the desired computing service resource structure and a separate description of the infrastructure elements. The declarative description is given in a Concrete Resource Model. A method of the invention determines how to assemble a desired service environment from the building blocks available in the infrastructure, or how to change the composition of resources allocated to an existing service environment to meet new requirements. The provisioning actions that are generated can be embodied in a form such as a workflow that would serve as input to a provisioning engine.

The operating environment may possesses any of the characteristics listed below. Although the present invention is not dependent on these characteristics, the method is general enough to handle such conditions and characteristics.
First, resources may be allocated to customers in combinations which are heterogeneous, may be interdependent, and vary over time.
Second, the service environments provided to each customer may be different. For example, one customer may be provided resources for a web site, and another for a scientific computing cluster. Resource types, quantities, dependencies, and allocation patterns will thus vary between customers.
Third, there can be multiple ways to construct a service environment from the resources in a service provider's infrastructure. A customer may have preferences or requirements for particular variations of a given service environment. A service provider may also have operational constraints that dictate which variations are acceptable.
Fourth, the infrastructure varies between service providers. Further, for a given service provider, the infrastructure varies over time. These variations can be a result of upgrades or additions to the physical infrastructure.

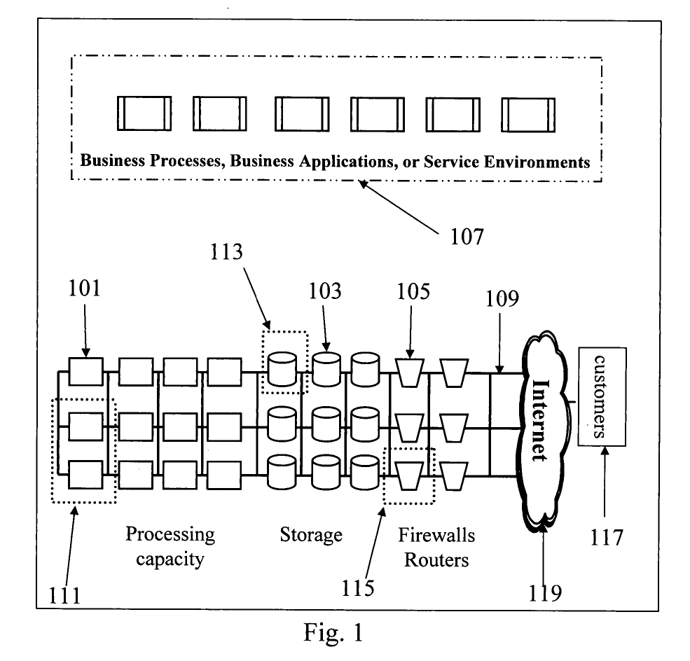

The system in which the present invention is used is a distributed computer system which has multiple computing resources interconnected via a network. A diagram of such a system, which might be found in a hosting or data center, is shown in FIG. 1. The computing resources in the physical infrastructure include, but are not limited to, processors 101, storage 103, firewalls 105, and software 107. The software can be operating systems, middleware or applications. In FIG. 1 the available software has been preconfigured into Business Processes, Business Applications, or Service Environments 107. The hardware resources are connected by a network 109 as indicated by the grid of lines interconnecting all of these resources. This network may be configure into one or more tiers, where each tier is separated by a router or firewall. Software resources are assigned to physical resources by a management infrastructure. In this environment a subset of the resources are assigned to the management infrastructure. In FIG. 1 these resources 111, 113, and 115 are indicated by a dotted line surrounding them. The resources assigned to the management infrastructure run the management software described in this invention. This software manages the rest of the resources. The resources used for the management infrastructure are not assigned to customers of the hosted environment. The remaining resources are assigned to customers as necessary. It is expected that customers 117 will primarily receive service by connecting to their resources through the Internet 119. However, customers can receive service if they are connected to their resources by any means, such as through a direct connection to a managed resource.

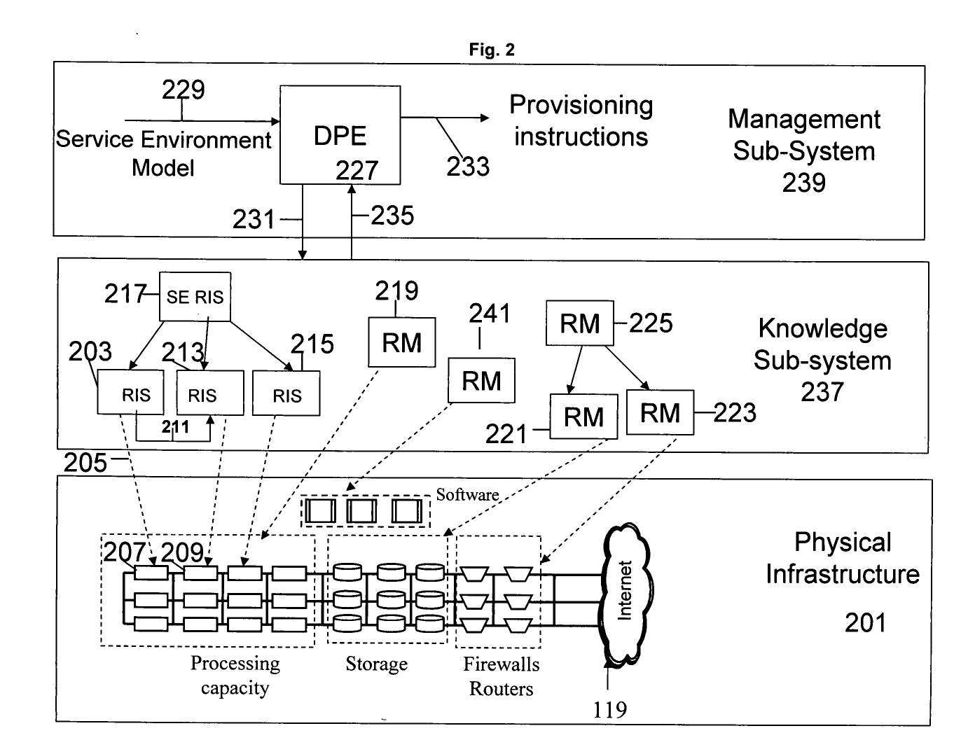

FIG. 2 is a high level view of the elements that are described in this invention. They can be divided into three groups. The physical infrastructure 201 is the actual set of inter-related resources as described in FIG. 1. The knowledge subsystem 237 includes a set of management entities that represent and control the resources. In particular, every resource is represented and controlled by a service with some canonical interfaces, termed a Resource Instance Service (RIS). RIS 203 in the figure represent resource 207 as indicated by the dashed arrow 205 connecting them. Relationships and dependencies between resources in the physical infrastructure are represented, in the knowledge subsystem, by a canonical set of relationships between the corresponding RISs. The relationship 211 between RISs 203 and 213 indicate an inter-dependency between the corresponding 207 and 209 resources. The nature of this interdependency can be inferred by data associated with the relationship (such as type of relationship), not shown in the figure. Composite resources can also be represented and controlled by a RIS. For example, RIS 217 represent a composite resource which is a service environment (SE). A relationship of type federates connects RIS 217 with the three RISs 203, 213, and 215, as the arrows indicate. This relationship means that the three corresponding resources in the physical infrastructure are allocated to the service environment that RIS 217 represents. Resource Managers (RMs) represent and manage collections of resources of the same type. In particular, they provide an operation that returns a handle to a free resource instance. RM 219 manages the set of processing capacity resources. RMs 221, 223, and 241 manage the collections of storage firewall, and software licenses resources, respectively. A composite resource type may also have an RM that encapsulates the knowledge of how to build the composite resource from other resources. An RM for a composite resource may use the RMs of the resources that comprise the composite resource. For example, in the figure, RM 225 is an RM for a secure storage composite resource; it uses RMs 221 and 223, as the arrows indicate. Together, RMs and RISs encapsulate knowledge of resources capabilities, how resources can be changed, how they can be associated with other resources, and what resources are currently free or allocated. In managing resources, RMs and RISs implement methods that affect changes on the resources they manage. These methods may be implemented in any way such as by scripts or by a provisioning engine.

The management subsystem 239 includes a Concrete Model Processing Engine (CMPE) 227 which receives requests in the form of a Concrete Resource Model that describes a desired resource structure. The CMPE generates provisioning actions 233 to reach a state that satisfies the requirements specified in the Concrete Resource Model. Once these provisioning actions are executed, either by the CMPE, or by the CMPE using a provisioning engine, they affect the state of the system. For example, a request may describe a new resource structure for an existing or non-existing service environment. Processing of a request results in provisioning actions that may create a service environment or change the combination of resources allocated to a service environment. In effect, the provisioning actions create a resource structure that matches the description in the Concrete Resource Model. To generate the provisioning actions the CMPE queries the knowledge subsystem, as indicated by arrow 235, to understand the state of the system and how it can be changed. The CMPE generates provisioning actions that include invocations of operations on knowledge subsystem entities, thus execution of a sequence of provisioning actions affects the state of the system (resources in the physical infrastructure), only through interaction with the knowledge subsystem (arrow 231), and not directly. The generation and execution of provisioning actions may be interleaved; to serve a request, a sequence of provisioning actions may be generated and executed before the next sequence is generated; a sequence of provisioning actions may be regenerated if its execution fails.

It is important to note that the same method can be applied inside a RM for a composite resource. Thus, the method can be applied to automatically generate a RM for a composite resource type based on its definition using a Concrete Resource Model. The generated RM provides a set of methods to create, destroy, or modify a composite resource based on a Concrete Resource Model that describes its desired structure. The RM can be then used as any other RM by a higher level CMPE. Such a strategy in fact distributes the CMPE method across infrastructure entities. It also allows to easily create and reuse provisioning components in different level of granularity.

Modeling Concepts

Both the representation of the infrastructure using a Knowledge Subsystem and the description of the desired service environment using a Concrete Resource Model rely on concepts taken from the object-relationship paradigm. The Concrete Resource Model is an object-relationship model. It can be implemented using UML, XML, relational databases, or similar technologies. A node in this invention represents a resource of a group of resources. Relationships between objects in the model represent relationships between resources. A set of relationship types is used to represent the type of relationship. In particular, in the description of the invention we use the following relationship types, defined below.
A uses B: if a resource A uses a resource B to perform its function.
A hosts B: if the resource A is a runtime container for B. For example: Server host OS, OS hosts application, WAS (WebSphere Application Server) hosts Enterprise Java Bean.
A connects B: if A and B are connected (i.e., communication between A and B is possible).
A federates B: if A is a resource that is a federation of other resources including B. Namely, A represents a set of heterogeneous resources that cooperate in order to perform a higher level function. For example, if a Web-site is a federation of Web-servers, databases, and load-balancers, the following relationships are implied: Web-Site federates Web-server, Web-site federates database, etc. Note that a composite resource is actually modeled as a resource that federates the set of resources comprising it.
A contains B: if A is essentially a set of homogeneous resources. For example, VLAN includes a Switch Port.

The invention does not assume any particular relationship type set. In particular, any relationship type set can be used in a model. For the invention to work, each relationship type will have to be mapped to an automation procedure in the knowledge subsystem for establishing or un-establishing it. This mapping will be discussed later.

The Knowledge Subsystem

An knowledge subsystem describes the resources and the organization of resources in the service provider's infrastructure. It includes the resource types and capabilities and information on physical connectivity, such as the number of network adapters and the position of firewalls. Infrastructure knowledge is distributed across entities of the knowledge subsystem, such as RMs and RISs. In order to obtain knowledge necessary for its function the CMPE may query entities of the knowledge subsystem.

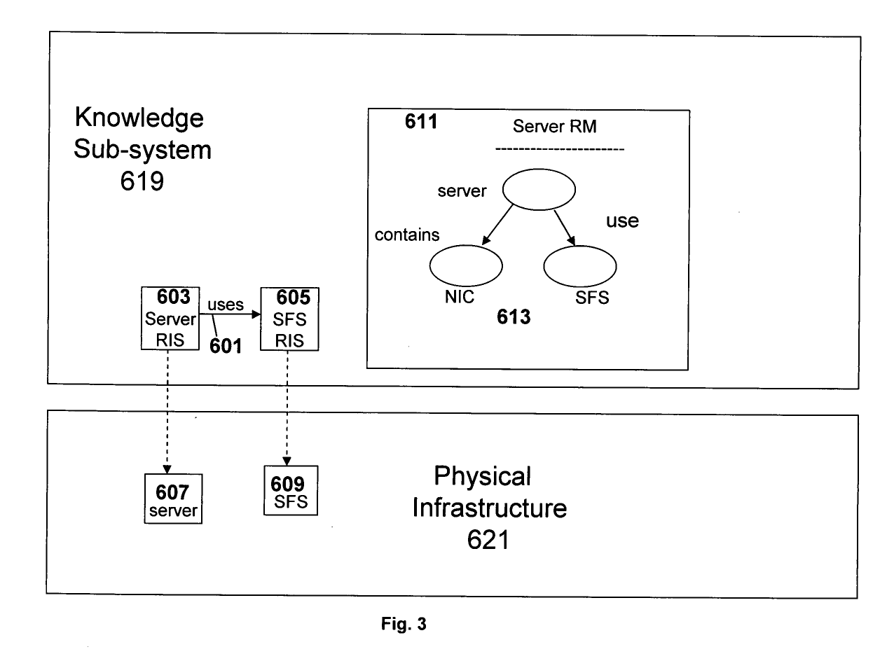

FIG. 3 describes infrastructure knowledge and the way it might be distributed among knowledge subsystem entities. In the knowledge subsystem (619) RISs 603 and 605 represent resource instances 607 and 609, respectively. Relationships between RISs represent operational dependencies between the corresponding resources. For example, the relationship 601 of type uses between RIS 603 representing server 607 and RIS 605 representing shared file system (SFS) 609 indicates that the server 607 uses the shared file system 609. A RIS can be queried for its set of relationships, as well as for values of configuration attributes of the resource it represents. RMs manage collections of resources of the same type. RMs can be queried to obtain information about the collection, and to obtain information on a type level. For example, server RM 611 encapsulates a server type model 613 that can be queried for possible relationships of a server resource to other resources. The set of possible server relationships will include the aforementioned uses relationship between a server and a shared file system, as well as other relationships that the server may have. The knowledge subsystem also includes information on infrastructure constraints and capabilities. Infrastructure constraints can be expressed using rules, assertions or other mechanisms. We also use attributes on relationships (on a type or instance basis) to express constraints.

Following are some mechanisms that can be used to describe such infrastructure constraints. A fixed attribute on a relationship expresses that the relationship between the two corresponding resources cannot be changed by a provisioning action. For example, in a wire-and-forget environment, where resourced are wired exactly once to a set of switches, and the wiring cannot be changed, a connects relationship between a Network Interface Card (NIC) and a Switch Port (SP) will have the fixed attribute.

The Concrete Resource Model

The Concrete Resource Model is the input to the CMPE process. It declaratively describes a desired resource structure which may include new resources added to an existing or new service environment, or resources removed from it. The goal of the CMPE process is to generate such a resource structure on the computing utility infrastructure.

In a Concrete Resource Model, nodes represent resources, and requirements on the state of these resources. Edges represent relationships between resources. Every edge is associated with a list of attributes that describes the nature of the relationship. A node may include a set of constraints on values of attributes of the resource that it represents. The values of some of these attributes are fixed, namely, they cannot be changed. Therefore, the constraints on these attributes are used as selection criteria for a resource that will serve the role of this node in the final resource structure that implements the Concrete Resource Model in the end of the provisioning process.

As in the knowledge subsystem, relationships between nodes in the Concrete Resource Model may be fixed or dynamic. Fixed relationships cannot be changed; they reflect fixed infrastructure structures and operational constraints. Thus, such relationships must be taken into account in the selection of the resources. For example, if a Concrete Resource Model includes a server node with a fixed contains relationship with three NICs then only a server with (at least) three NICs can be selected for this node. A dynamic relationship can be established by invoking a low level automation procedure on one (or more) of the knowledge subsystem entities. For example a dynamic connects relationship may be established between switch port and VLAN resources by programmatically configuring switches or routers.

In the preferred embodiment an edge, representing a relationship, is associated with a set of attributes that describe the nature of the relationship. Attributes describe the type of relationship (e.g., federates), and whether it is fixed or dynamic. A color attribute with value green denotes that the relationship must exist between the corresponding resources. The same attribute with value red denotes that the relationship must not exist between the corresponding resources. Clearly, the nature of the relationship, and assertions on whether it should be present or absent in the resulting resource structure, can be expressed in many different ways, the color attribute is just one way to do that.

A Concrete Resource Model is fully implementable on a given infrastructure represented by a knowledge subsystem if it is mappable onto the knowledge subsystem. More specifically, every node in the Concrete Resource Model that represents a resource has to be mappable, directly or indirectly, to either an RM or an RIS. Every relationship has to be mappable to an automation procedure to establish it (or unestablish it). The mapping might be indirect; if one resource, say a server, has a fixed relationship with a different resource, say a NIC, then only the server node in the Concrete Resource Model needs to be mappable to a server RM. During the CMPE process, a server RIS can be obtained from the server RM, and a NIC RIS can then be obtained from the server RIS. Note that the NIC is represented in the server type model encapsulated by the server RM. This condition will be further explained when discussing the operation of the CMPE. If only parts of the Concrete Resource Model can be mapped to the knowledge subsystem then the method of the invention can still be applied to create a resource structure than matches in parts with the Concrete Resource Model.

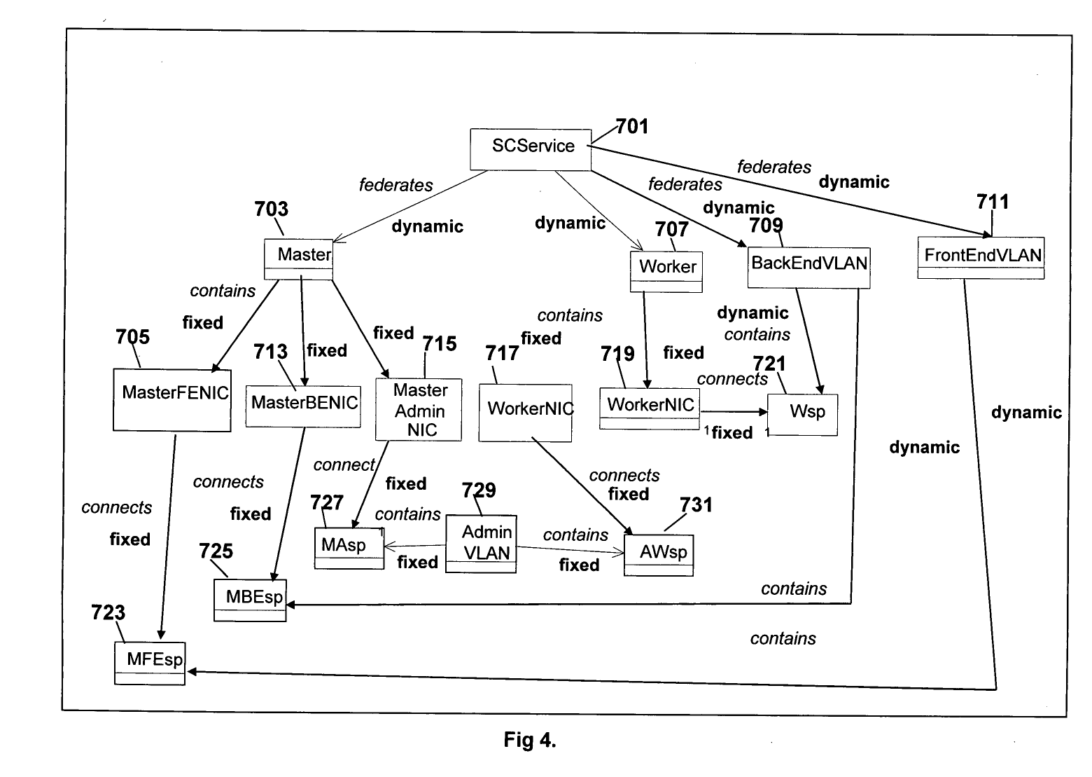

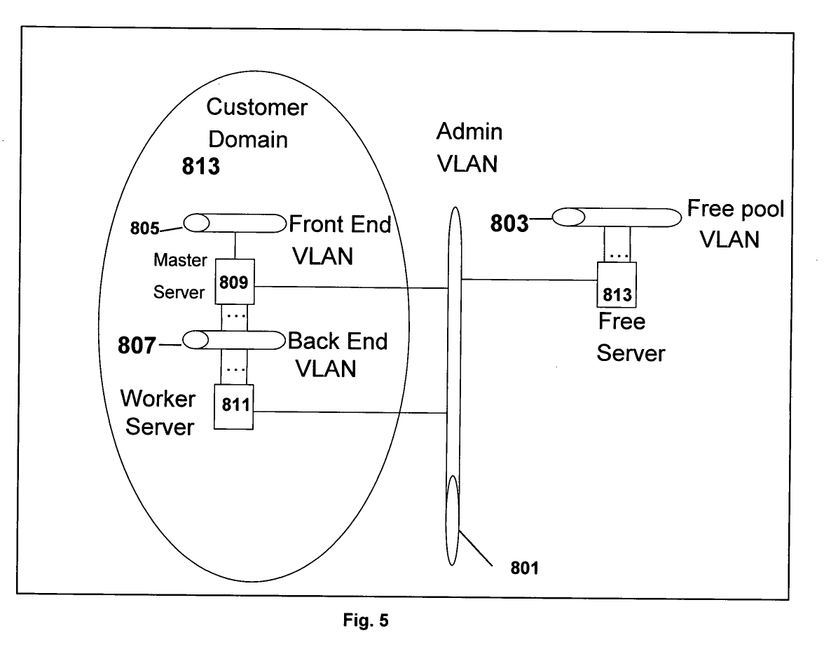

FIG. 4 shows an example of a Concrete Resource Model for a scientific computing cluster service described in FIG. 5. In this system every server (depicted in FIG. 5 as a box) is connected to a designated Admin VLAN 801. A free server 813 has all of its other NICs connected to a designated Free-pool VLAN 803. A service environment 813, is a scientific computing cluster environment which includes a single master server 809, connected to both a front end VLAN 805 and a back end VLAN 807, and a set of worker servers connected to the back end VLAN. Both Master and Worker servers are also connected to the Admin VLAN.

In FIG. 4, the root node 701 is an object that represents the service environment itself; it federates four resources: a master node 703, a set of zero or more worker nodes 707, a front end VLAN 711, and a back end VLAN 709. The master node includes three network adapters (NICs): one 715 connecting it through a switch port 727 to the Admin VLAN 729, one 705 connecting it through a switch port 723 to the front end VLAN 711, and one 713 connecting it through a switch port 725 to the back end VLAN 709. The worker node includes two network adapters: one 717 connecting it through a switch port 731 to the admin VLAN, and one 719 connecting it through a switch port 721 to the back end VLAN. VLANs group switch ports; Each VLAN is represented by a node which includes one or more switch ports.

The relationships between NICs and the servers and the NICs and the switch ports are fixed relationships. They are defined when the example infrastructure is set up and this physical connection is considered to be permanent. Such is also the case for the contains relationship between the Admin NIC and a set of switch ports, as the servers in this example are to remain permanently connected to the Admin VLAN. The dynamic relationships need to be established by the CMPE after the resources, represented by the nodes in the Concrete Resource Model, are selected. An example of a dynamic relationship is the relationship between the Back End VLAN 709 and the switch ports that it includes (725 and 721). This relationship is established by programmatically re-configuring the switches. The CMPE identifies such tasks and invokes the corresponding procedures in the knowledge subsystem to carry them out.

CMPE Operation

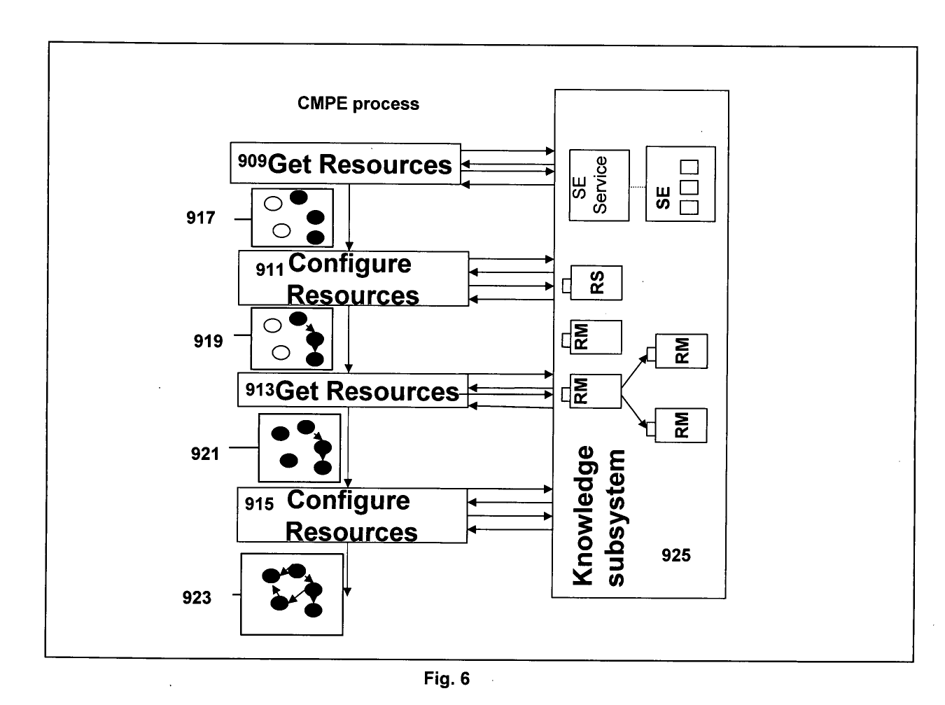

FIG. 6 is an example of an execution of the CMPE which illustrates the process of performing provisioning based on a Concrete Resource Model. The input to the process is a Concrete Resource Model 907. During the execution of the process, resources corresponding to nodes in the Concrete Resource Model are selected or created and relationships between them are established by interacting with the RMs in the knowledge subsystem. There may be multiple phases in which resources are selected or created and then configured to establish the corresponding relationships. In this example, after step 909 three resources are selected; the corresponding nodes are shown in black 917. In step 911 two relationships between the selected resources are established as depicted in 919. In step 913 the rest of the resources are selected as shown in 921. Finally, in step 915 all (dynamic) relationships between the resources are established as shown in 923. After the termination of the process, a structure matching the Concrete Resource Model structure is created in the knowledge subsystem. Hereafter we describe the process in more detail.

The CMPE generates and executes provisioning actions to create a resource structure that matches the Concrete Resource Model. A provisioning action sequence includes two types of provisioning actions: an action to select a resource, and an action to configure a resource or relationship. Usually a sequence corresponding to a single request will include multiple sub-sequences, termed phases, in which resources are selected and then configured. The number of phases depends on the complexity of the system.

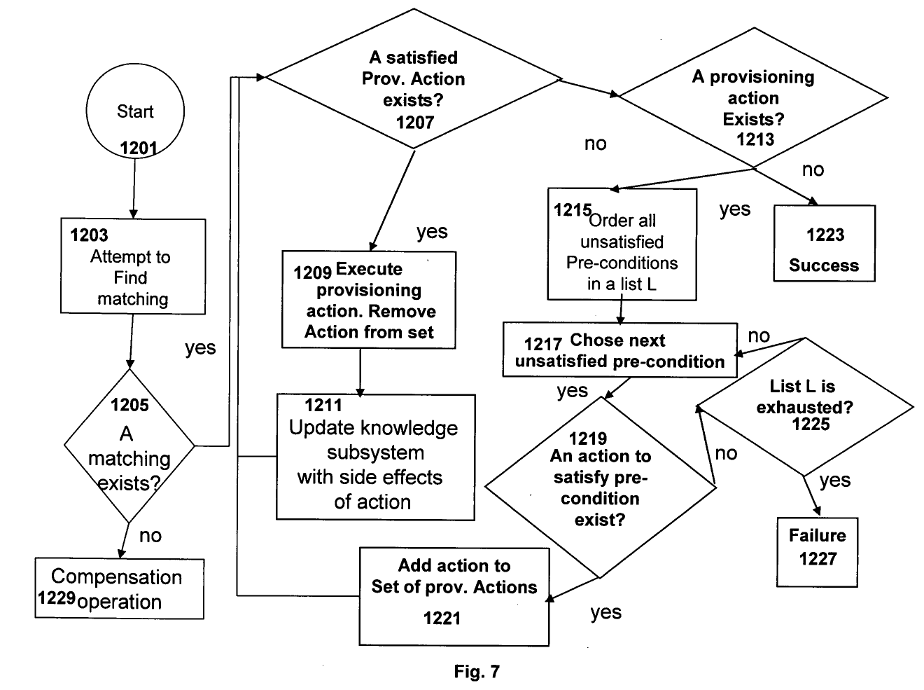

A single phase of the CMPE process is described in FIG. 7. Essentially, in a single phase, starting in step 1201, a set of infrastructure resources are selected and mapped to nodes in the Concrete Resource Model (1203). This matching defines a set of provisioning actions of two types: a provisioning action to configure a resource, and a provisioning action to establish or unestablish a dynamic relationship. A provisioning action may have preconditions. A provisioning action can be executed only if its preconditions are satisfied. In step 1209 a provisioning action whose preconditions are satisfied is executed. An execution of a provisioning action may have side effect in the physical infrastructure. In step 1211 these side effects are reflected back in the knowledge subsystem by creating or destroying the corresponding relationships or changing the values of attributes in the corresponding Resource Instance Services (side effects will be further explained later.)

If all provisioning actions are executed successfully (1213) then the current phase of the CMPE process terminates successfully (1223). If all nodes of the Concrete Resource Model were matched in this or previous phases then the process terminates successfully and the entire structure described in the Concrete Resource Model is now built in the physical infrastructure and reflected in the knowledge subsystem. Otherwise, another phase is performed.

In some cases, a provisioning action whose preconditions are not satisfied exists (1213). In this case, a different action to satisfy an unsatisfied precondition, if exists, is added to the set of provisioning actions that need to be executed (1221). If actions exist whose preconditions are not satisfied, and there do not exist any precondition that can be satisfied by executing a different action (1219 and 1225) then the process fails (1227). In general, it may be the case that an action to satisfy a precondition also has preconditions. The method is applied recursively and may lead to a chain of actions that are executed in order to satisfy the precondition of the original provisioning action, this case is taken care of by adding an action to satisfy a precondition to the set of provisioning actions (1221).

We now describe some aspects of the process in more details. In the matching step, selection of resources is based on two conditions: when a node is matched with a corresponding Resource Instance Service the values of fixed attributes as defined in the Resource Instance Service must satisfy constraints on these attributes defined in the node. In addition all edges that represent fixed relationships with the node as an endpoint in the Concrete Resource Model must match the set of fixed relationships of the matching Resource Instance Service in terms of type of relationship, direction of relationships, and matching endpoint nodes. Other criteria, such as multiplicity, if defined, can also be matched against. For example, if a node A in the Concrete Resource Model is connected by an edge to a node B in the Concrete Resource Model and annotates with type x and color green then there has to be a relationship of type x between the Resource Instance Service A′ that is matched with the node A and the Resource Instance Service B′ that is matched with the node B, moreover the direction of the relationship should be identical to the direction of the aforementioned edge. If the color of the aforementioned edge is red, then there must not be such a relationship between A′ and B′ in the knowledge subsystem. The matching algorithms works by interacting with the RMs. For every node, an operation is executed on the corresponding RM to find and obtain a set of Resources Instance Services that are potential match for the node. The RMs may accept some selection criteria (in the form of constraints over values of attributes) which are defined in the node and passed as parameters to a find operation. These selection criteria only serve for the initial filtering. Additional filtering must be done by the CMPE so that the matching condition defined above is satisfied. The matching is intricate since when selecting a resource (represented by a Resource Instance Service) it is not enough to look only at its immediate fixed relationships; a selection of a resource may dictate selection of a different resource (with whom it has a relationship) so the latter one must also have the correct set of fixed relationships recursively. To do the matching, the CMPE employs well known graph matching techniques. These techniques backtrack and try the next possibility whenever a matching possibility fails.

Once the matching is complete, a subset of the nodes is mapped to Resource Instance Services, such that the set of fixed relationships and attributes in the Concrete Resource Model matches the corresponding relationships and attributes in the knowledge subsystem. This includes fixed relationships between nodes that are both matched in this phase, or between nodes one of which is matched in this phase and the other was matched in previous phases. In 1203, if a nontrivial matching (i.e., matching of size greater than 0) exists, then the process proceeds to configuring the resources, starting at 1207, otherwise the process fails in 1205. A process may fail due to many reasons. For example, it may not be possible to map the pattern defined by the set of fixed relationships to the infrastructure at hand. For example, if a node representing a server has 3 fixed contains relationships with nodes representing NICs and all servers in the infrastructure have fewer than 3 NICs.

If a matching cannot be found the entire process fails (1205). Since some allocation and configuration actions may already have been performed, a compensation action needs to take place to restore the system state (1229). This may be done by recursively calling the CMPE with a new request such that the new desired state is the original state before the current CMPE process started, other alternatives, such as keeping a log and rolling back, may also be used. Alternatively, the algorithm can be easily generalized to find a non-optimal solution in which a resource structure similar but not identical to the description in the Concrete Resource Model is found.

Once Resource Instance Services are selected and mapped to a subset of the nodes in the model, they are configured to establish the set of dynamic relationships described in the model and to change values of dynamic attributes to satisfy the constraints defined in the Concrete Resource Model. This is done by interacting with knowledge subsystem entities that encapsulate the logic to configure the resources. Different knowledge subsystem entities may encapsulate automation procedures to establish (or unestablish) different relationships. For example, a RM for a composite resource may encapsulate the knowledge to establish all relationships between resources in the composite. The invention does not make any assumption on the architectural location of these automation procedures. It only assumes that such low level automation procedures exist, and that there exists a mapping, accessible to the CMPE, between a relationship and the automation procedure to establish or unestablish it, and between an attribute and the operation to set its value. An automation procedure will typically receive as parameters the handles for resources involved and configure them to implement the semantics of the relationship or attribute. The CMPE is responsible for updating the corresponding Resource Instance Services with the information on the established relationship or value of attribute.

As explained above, a matching of a set of Concrete Resource Model nodes and a set of Resource Instance Services defines a set of provisioning actions that must be executed. The set includes two types of provisioning actions: to configure a node and to establish or unestablish a relationship. Specifically, for every node in the Concrete Resource Model, for every attribute whose value is different then the value of the attribute in the matching Resource Instance Service, a provisioning action must be performed on the Resource Instance Service to change the value of the attribute. For every edge representing a dynamic relationship in the Concrete Resource Model, a provisioning action must be performed to establish the relationship in the knowledge subsystem if the relationship do not exist. For every red edge in the Concrete Resource Model, if a corresponding relationship exists in the knowledge subsystem it must be un-established.

For example, a resource, say of type Web server, may have an attribute state whose value in the Concrete Resource Model is set to started. In the knowledge subsystem the values of the state attribute may be created. A provisioning action must be performed to change the value from created to started. The process can work as follows. An operation setAttribute is invoked on the Resource Instance Service with parameters that are the name of attribute and the new value (“state”, and, “started”, correspondingly). This operation triggers an automation procedure which affects the physical infrastructure by starting the Web server that is represented by the Resource Instance Service. For a relationships, consider as an example a relationship of type contains between a Switch Port and a VLAN. An establishRelationship provisioning action can be invoked in the knowledge subsystem that will trigger an automation procedure that affects the physical infrastructure by programmatically configuring the switch to move the designated switch port in the designated VLAN.

Back in FIG. 7, the configuration is a 3 step process; first, in 1207 all dynamic relationships and attributes between matched resources are collected by analyzing the Concrete Model and mapped to the corresponding provisioning action, second, in 1209, a provisioning action whose preconditions are satisfied is executed.

As mentioned, a provisioning action may have side effects that need to be reflected back in the knowledge subsystem. A side effect is any state change that is beyond the property that is the target for which the automation procedure was invoked. An example of a side effect of the operation to start a Webserver, described above, may be the creation of a use relationship between the Webserver and a database resource. In this case, step 1211 involves updating the knowledge subsystem with the aforementioned use relationships. Side effects may be modeled and described in an inspectable way for every operation in the knowledge subsystem that affects the physical infrastructure. Alternatively, they may be discovered by a different discovery component after the operation is executed. In the later case once a provisioning action is executed, the discovery component is executed and its output is used to update the knowledge subsystem in Step 1211. In some settings the users of the system may decide that some relationships are not important for the management of the system and they can be ignored altogether.

Although the present invention may be employed by many types of entities, it is particularly useful for use by a service provider, an enterprise owning an infrastructure used for running at least one application, a customer of a service provider, a company owning an IT infrastructure, and a utility provider.

The present invention includes a method for provisioning in a computing utility infrastructure. The method comprising: obtaining a Concrete Resource Model describing a desired resource structure; and using the Concrete Resource Model to generate at least one provisioning action to create a matching resource structure in the computing utility infrastructure.

In some embodiments of the method: the step of using the Concrete Resource Model includes executing at least one phase comprised of a matching step and a configuring step, wherein the steps of matching and configuring are repeated until the Concrete Resource Model is entirely matched with a set of at least one Resource Instance Service in said knowledge subsystem; and/or the step of matching includes mapping every node in a subset of nodes in the Concrete Resource Model to a Resource Instance Service in the knowledge subsystem, such that for every node in said subset, constraints on values of fixed attributes in said node are satisfied by the values of the same attributes in the corresponding Resource Instance Service, and the set of fixed relationships between matched nodes matches the set of relationships between the corresponding Resource Instance Services; and/or the step of configuring includes: selecting a provisioning action having all preconditions satisfied, executing the provisioning action, and updating the knowledge subsystem with side effects of the provisioning action, and repeating the steps of selecting and executing until all provisioning actions whose preconditions are satisfied are executed; and/or the step of configuring includes selecting a provisioning action having at least one precondition not satisfied, adding said different action to satisfy said at least one precondition to a provisioning action set to be executed; and/or further comprises obtaining said side effects of an action by at least one of: inspecting the definition of said provisioning action in said knowledge subsystem, and dynamically discovering the side effects once the action is executed by executing a discovery component.

In further embodiments the step of provisioning includes at least one task taken from a group of tasks consisting of: creating a new service environment; changing a combination of resources allocated to the service environment; changing the configuration of resources allocated to a service environment; destroying a service environment; and any combination of these tasks.

In some embodiments the step of changing the configuration of resources allocated to a service environment includes at least one of: changing a local state of a resource; and changing a way the resource is configured to work with other resources.

In some further embodiments, the method further comprises regenerating provisioning instructions whenever at least one of the following occurs: infrastructure characteristics change; and requirements of the service change; and/or employing said Concrete Resource Model to generate a Resource Manager for a composite resource.

In some embodiments of the method, infrastructure characteristics are taken from a group of characteristics consisting of: types of resources in the infrastructure; capabilities of said resources; configuration of said resources; constraints on a configuration of said resources; and any combination of these characteristics.

In some embodiments the method is employed to automatically generate a Resource Manager for a composite resource; the Resource Manager provides a set of resource manager methods taken from a group of resource manager methods consisting of: creating composite resources based on a Concrete Resource Model; changing composite resources based on a Concrete Resource Model; destroying composite resources based on a Concrete Resource Model; and any combination of these resource manager methods.

In some embodiments of the method, the execution specification is taken from a group of execution specifications consisting of: execute immediately; stored and executed later at least once; and a combination of the above.

In some embodiments of the invention is an apparatus for provisioning in a computing utility infrastructure, the apparatus comprising: means for obtaining a Concrete Resource Model describing a desired resource structure; and means for using the Concrete Resource Model to generate at least one provisioning action to create a matching resource structure in the computing utility infrastructure.

Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1. A method for provisioning in a computing utility infrastructure, the method comprising:
obtaining a Concrete Resource Model describing a desired resource structure; and
using the Concrete Resource Model to generate at least one provisioning action to create a matching resource structure in the computing utility infrastructure.

2. A method as recited in claim 1, wherein the step of using the Concrete Resource Model includes executing at least one phase comprised of a matching step and a configuring step, wherein the steps of matching and configuring are repeated until the Concrete Resource Model is entirely matched with a set of at least one Resource Instance Service in said knowledge subsystem.

3. A method as recited in claim 2, wherein the step of matching includes mapping every node in a subset of nodes in the Concrete Resource Model to a Resource Instance Service in the knowledge subsystem, such that for every node in said subset, constraints on values of fixed attributes in said node are satisfied by the values of the same attributes in the corresponding Resource Instance Service, and the set of fixed relationships between matched nodes matches the set of relationships between the corresponding Resource Instance Services.

4. A method as recited in claim 2, wherein the step of configuring includes:
collecting provisioning actions to a provisioning action set;
selecting a provisioning action having all preconditions satisfied;
executing the provisioning action, and updating the knowledge subsystem with side effects of the provisioning action; and
repeating the steps of selecting and executing until all provisioning actions whose preconditions are satisfied are executed.

5. A method as recited in claim 2, wherein the step of configuring includes selecting a provisioning action from a provisioning action set having at least one precondition not satisfied,
finding a different action to satisfy said at least one precondition; and
adding said different action to said provisioning action set

6. A method as recited in claim 4, further comprising obtaining said side effects of an action by at least one of:
inspecting the definition of said provisioning action in said knowledge subsystem; and
dynamically discovering the side effects once the action is executed by executing a discovery component.

7. A method as recited in claim 1, wherein the step of provisioning includes at least one task taken from a group of tasks consisting of:
creating a new service environment;
changing a combination of resources allocated to the service environment;
changing the configuration of resources allocated to a service environment; and
destroying a service environment; and
any combination of these tasks.

8. A method as recited in claim 7, wherein changing the configuration of resources allocated to a service environment includes at least one of:
changing a local state of a resource; and
changing a way the resource is configured to work with other resources.

9. A method as recited in claim 1, further comprising regenerating provisioning instructions whenever at least one of the following occurs:
infrastructure characteristics change; and
requirements of the service change; and
Provider's policy change.

10. A method as recited in claim 9, wherein infrastructure characteristics are taken from a group of characteristics consisting of:
types of resources in the infrastructure;
capabilities of said resources;
configuration of said resources;
constraints on a configuration of said resources; and
any combination of these characteristics.

11. A method as recited in claim 1, further comprising employing said Concrete Resource Model to generate a Resource Manager for a composite resource.

12. A method as recited in claim 1, wherein said Resource Manager provides a set of resource manager methods taken from a group of resource manager methods consisting of:
creating composite resources based on a Concrete Resource Model;
changing composite resources based on a Concrete Resource Model;
destroying composite resources based on a Concrete Resource Model; and
any combination of these resource manager methods.

13. A method as recited in claim 1, wherein the step of using is executed according to an execution specification.

14. A method as recited in claim 1, wherein said execution specification is taken from a group of execution specifications consisting of:
execute immediately;
stored and executed later at least once; and
a combination of the above.

15. An article of manufacture comprising a computer usable medium having computer readable program code means embodied therein for causing provisioning in a computing utility infrastructure, the computer readable program code means in said article of manufacture comprising computer readable program code means for causing a computer to effect the steps of claim 1.

16. A program storage device readable by machine, tangibly embodying a program of instructions executable by the machine to perform method steps for provisioning in a computing utility infrastructure, said method steps comprising the steps of claim 1.

17. An apparatus for provisioning in a computing utility infrastructure, the apparatus comprising:
means for obtaining a Concrete Resource Model describing a desired resource structure; and
means for using the Concrete Resource Model to generate at least one provisioning action to create a matching resource structure in the computing utility infrastructure.

18. A computer program product comprising a computer usable medium having computer readable program code means embodied therein for causing provisioning in a computing utility infrastructure, the computer readable program code means in said computer program product comprising computer readable program code means for causing a computer to effect the functions of claim 17.

19. A method as recited in claim 2, wherein said at least one phase is a Concrete Model Processing Engine phase, the Concrete Model Processing Engine:
receiving requests in the form of a Concrete Resource Model describing a desired resource structure; and
generating provisioning actions for reaching a state that satisfies the requirements specified in the Concrete Resource Model.

20. A method as recited in claim 1, wherein the steps of obtaining and using are performed by at least one user taken from a group of users consisting of:
a service provider;
an enterprise owning an infrastructure used for running at least one application;
a customer of a service provider;
a company owning an IT infrastructure; and
a utility provider.

21. A method as recited in claim 20, wherein at least one of said at least one user provides operational constraints dictating acceptable variations.
